(19) United States
(12) Patent Application Publication
(10) Pub. No.: US 2005/0217114 A1
(43) Pub. Date: Oct. 6, 2005

(54) Disposable blade cartridge utility knife

(76) Inventor: Earl Votolato, Newport Beach, CA (US)

Correspondence Address: WILLIAM W. HAEFLIGER, 201 S. LAKE AVE, SUITE 512, PASADENA, CA, 91101, US

(21) Appl. No.: 10/818,661

(22) Filed: Apr. 5, 2004

(51) Int. Cl. B26B 3/00

(52) U.S. Cl. 30/2

(57) ABSTRACT

In a knife, the combination, comprising a cartridge, a blade carried by the cartridge, a holder supporting the cartridge so that the blade projects from the holder, a shield for the blade, carried to be displaced relative to the holder and blade to expose the blade, for cutting.

### BACKGROUND OF THE INVENTION

This invention relates generally to cutting and/or slitting devices, as are used for opening boxes or cutting cardboard, and more particularly, to an improved device of simple, compact, heavy duty lightweight construction and enabling its throw-away disposal.

Most utility knives are such that they require raw loose blades to be changed out when the blade dulls. This results in the “dulled” blades ending up everywhere and contaminating everything from food to chemical batches to textile and clothing. The raw blades also are a safety hazard even when disposed of in a trash receptacle due to someone having the job of rummaging through the trash looking for something they should not have thrown out.

There is need for an improved utility knife that minimizes, if not eliminates such issues of safety and contamination.

There is need for devices, as referred to above, and in particular, there is need for very low cost such devices which are made to be disposed of without danger, themselves or their components. The device disclosed herein improves over those of U.S. Pat. Nos. 5,522,135 and 5,697,157 incorporated herein by reference.

### SUMMARY OF THE INVENTION

It is a major object to provide an improved knife or cutter or slitting device of simple, low cost, compact, simple component construction, and which is safe to use, and safe when disposed of by virtue of blade protection. Basically, the preferred device comprises:

a) a cartridge,

b) a blade carried by the cartridge,

c) a holder supporting the cartridge so that the blade projects from the holder,

d) a shield for the blade, carried to be displaced relative to the holder and blade to expose the blade, for cutting.

As will appear, the location of the blade on the cartridge is made for throw away, or replacement compatibility as respects the holder. In this regard, the shield is easily attached to the cartridge to enable its protection of the blade when disposed of. In this regard, the shield is typically pivotable relative to the cartridge and blade, onto which the shield is easily installed.

Another object is to provide the cartridge to be received by the holder to be removable and replaceable. When a replacement cartridge is then installed in or on the handle portion of the holder, the blade is in operating position, projecting endwise from—the handle portion of the holder.

Yet another object is to provide a detent connection holding the cartridge elongated portion to the elongated handle portion of the holder. That connection may include an easily operated push-in disconnection.

A further object is to provide handle portion ribs which extend generally transversely relative to handle portion length, and provide for positive gripping.

Additional objectives include provision of an improved knife or cutter, embodying one or more of the above features, and further characterized by:
1. Disposable blade cartridge,
2. Disposable blade cartridge with an automatically retractable protective blade guard or shield to assist in making the cartridge safe to handle when off and on the knife handle, including the time after which the cartridge is disposed of.
3. Cartridges can be color coded to provide for an easy identifier to the cartridge's use-special blade, cutting depth, special applications, etc.
4. Light-weight molded construction—inexpensive to produce—high impact plastic/polymer construction with the exception of the blade.
5. The handle can be made of plastic or metal.

These and other objects and advantages of the invention, as well as the details of an illustrative embodiment, will be more fully understood from the following specification and drawings, in which:

### DRAWING DESCRIPTION

FIG. 1 is a perspective view of a knife embodying the invention;

FIG. 2 is a view like FIG. 1, but showing a cartridge released from a knife handle;

FIG. 3 is an elevation showing one side of the cartridge, with a blade shield in closed position;

FIG. 4 is an edge view taken on lines 4-4 of FIG. 3;

FIG. 5 is an elevation showing the opposite side of the cartridge, with the blade shield in open position, to expose the blade;

FIG. 6 is a perspective view of the cartridge;

FIG. 7 is a side view in elevation like FIG. 3, but with one section of the two-section shield removed;

FIG. 8 is an edge view taken on lines 8-8 of FIG. 7;

FIG. 9 is a perspective view of one side of the cartridge, with the one shield section removed, and the other shield section in place;

FIG. 10 is an elevation view of the opposite side of the cartridge, with the other shield section removed, and the one section in place;

FIG. 11 is a side elevation view of the assembled shield showing one side thereof;

FIG. 12 is an edge view taken on lines 11-11 of FIG. 10;

FIG. 13 is an elevation view taken on lines 13-13 of FIG. 12, showing the opposite side of the assembled shield;

FIG. 14 is an edge view of the assembled knife handle;

FIG. 15 is a section taken on lines 15-15 of FIG. 14, showing interior construction of a handle section, and a guide for cartridge insertion;

FIG. 16 is an elevation taken on lines 16-16 of FIG. 14;

FIG. 17 is an elevation taken on lines 17-17 of FIG. 14;

FIG. 18 is an end view taken on lines 18-18 of FIG. 17;

FIG. 19 is an enlarged side elevation showing the cartridge blade;

FIG. 20 is an enlarged fragmentary view showing blade forward edge configuration; and

FIG. 21 is an edge view taken on lines 21-21 of FIG. 19.

### DETAILED DESCRIPTION

In the example, the knife 100 includes:

a) a cartridge, one example being shown at 10;

b) a blade carried by the cartridge body, one example of such a blade indicated at 11;

c) a holder supporting the cartridge so that the blade projects at 11a from the cartridge, one example of such a holder being indicated at 12; and

d) a shield for the blade, carried to be displaced relative to the holder to controllably expose the blade for cutting, one example of such a shield being shown at 13.

It will be understood that other forms of such elements 10-13 may be provided.

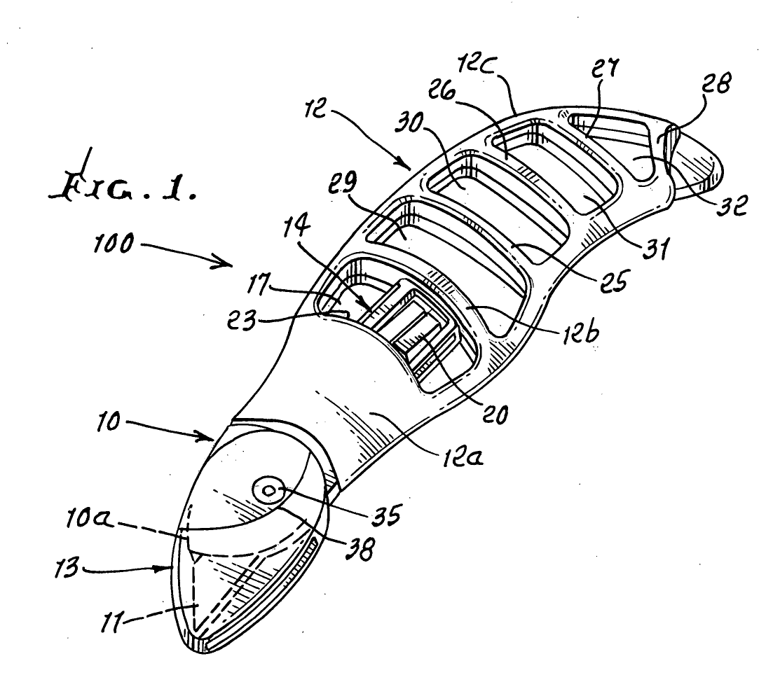

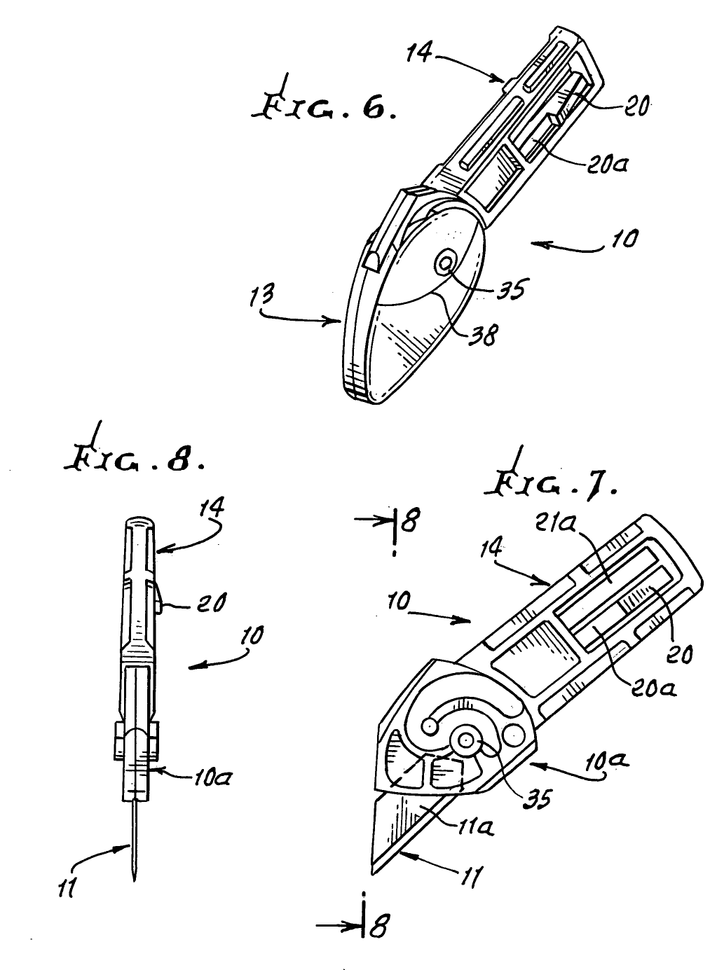

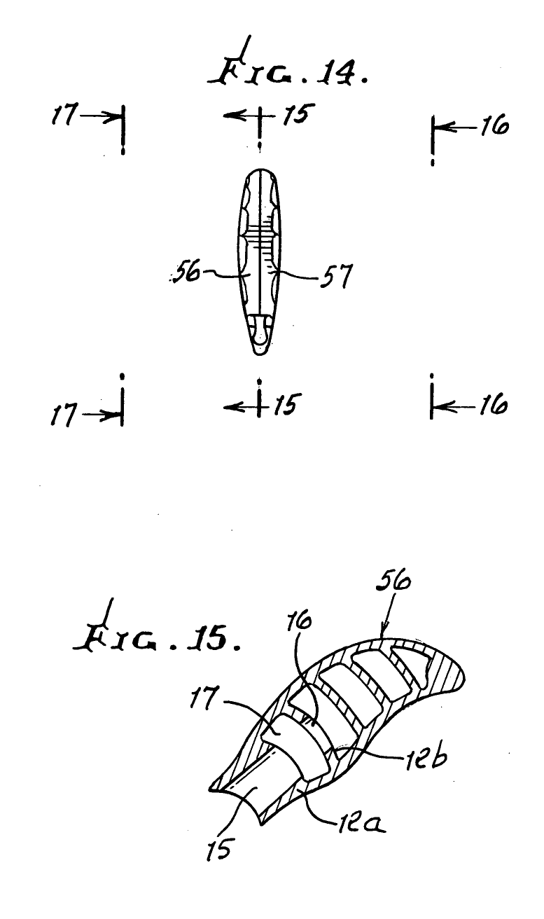

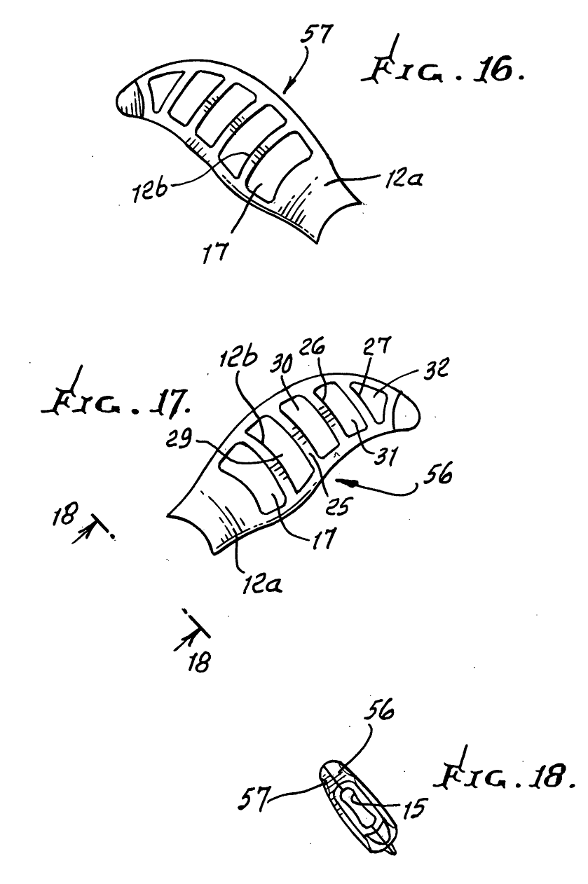

The illustrated cartridge 10 is configured to be receivable by the holder in such manner that it can be readily removable and replaced, thereby to enable blade replacement. The cartridge typically defines a blade carrying body portion 10a and a stem 14, shown in FIGS. 1, 3, 4 and 6-10. That stem is insertable endwise into the holder or handle 12 as via guide passages or slots 15 and 16 in holder portions 12a and 12b. See FIG. 15. The latter portion 12a and 12b are spaced apart endwise of the holder as shown to expose a sideward through opening 17 via which manual release of the cartridge is enabled. See for example the detents or catches 20 and 21 on spring arms 20a and 21a carried by the stem to be respectively exposed or presented at opposite sides of the holder via side through opening 17. When manually pushed or pinched oppositely inwardly, the catches release from engagement with shoulder 23 on the holder portion 12a to allow endwise slide-out removal of the cartridge stem from the holder. The latter may project at 12c in the form of a curved handle to be readily grasped by the user. Note the cross-pieces or transverse “bridges” 25-28 defined by the handle, with sideward through openings 29-32 therebetween, facilitating firm manual grasping at bridge edges during use, and without hand slippage. The handle includes opposed like sections 56 and 57 which are suitably attached together. See FIGS. 14-17.

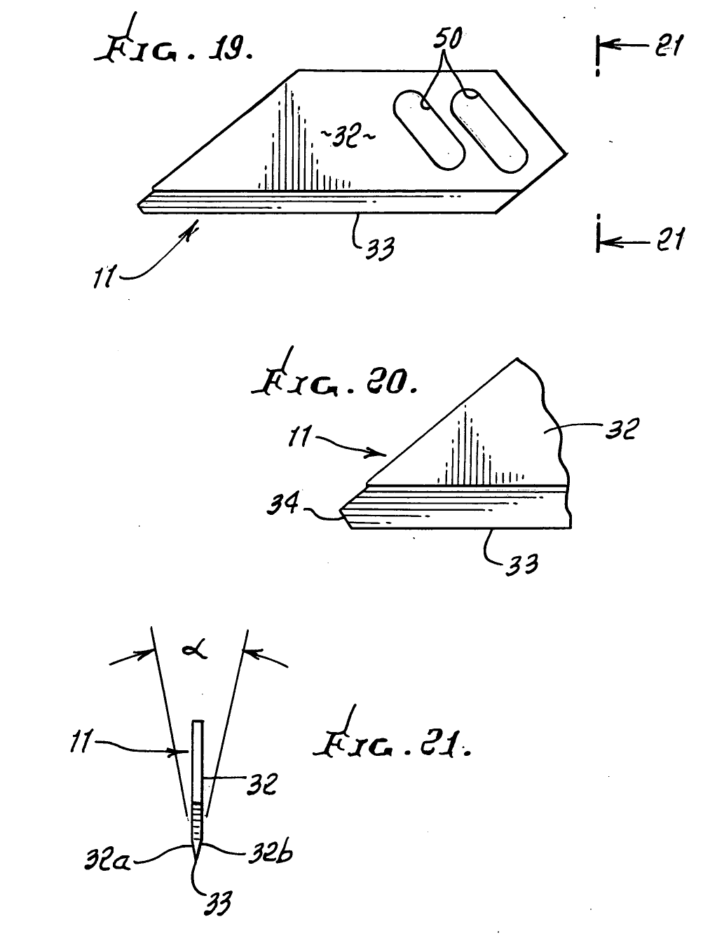

The metallic blade 11 may be integral with (for example molded to) the cartridge body portion 10a to project endwise. See FIG. 7, and See FIG. 19 showing openings 50 in the blade to receive plastic material of body portion 10a. As shown in FIGS. 19-21, the blade has a thin body 32, and an elongated cutting edge 33 formed by V-shaped intersection of opposite sides 32a and 32b of the body. The V-shaped angle a is formed by the sides, as seen in FIG. 21. Note bevel 34 at the forward end of edge 33.

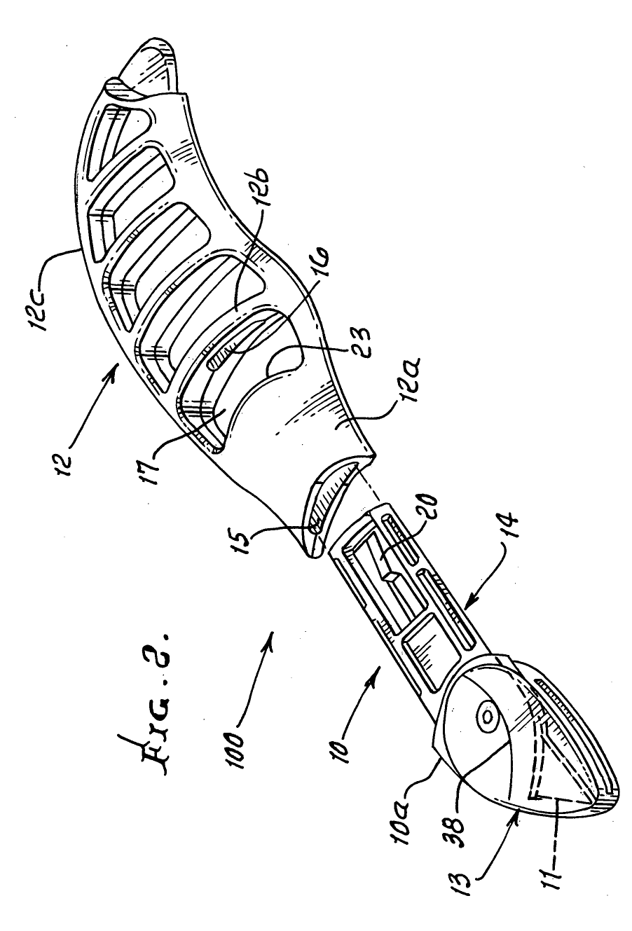

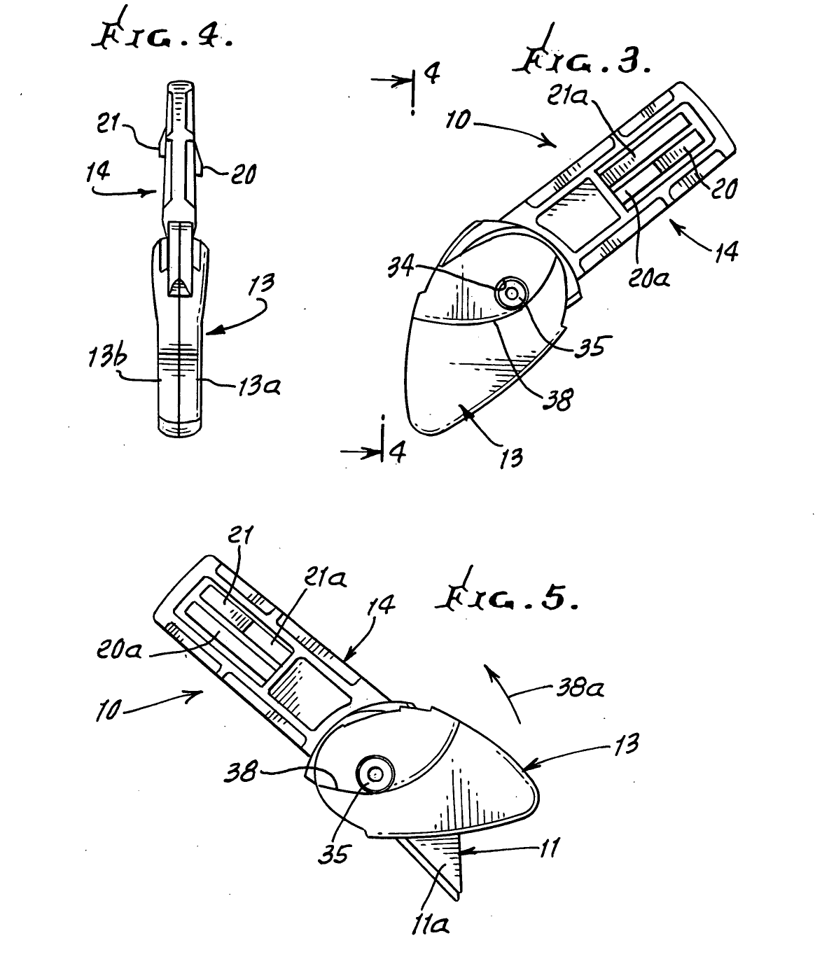

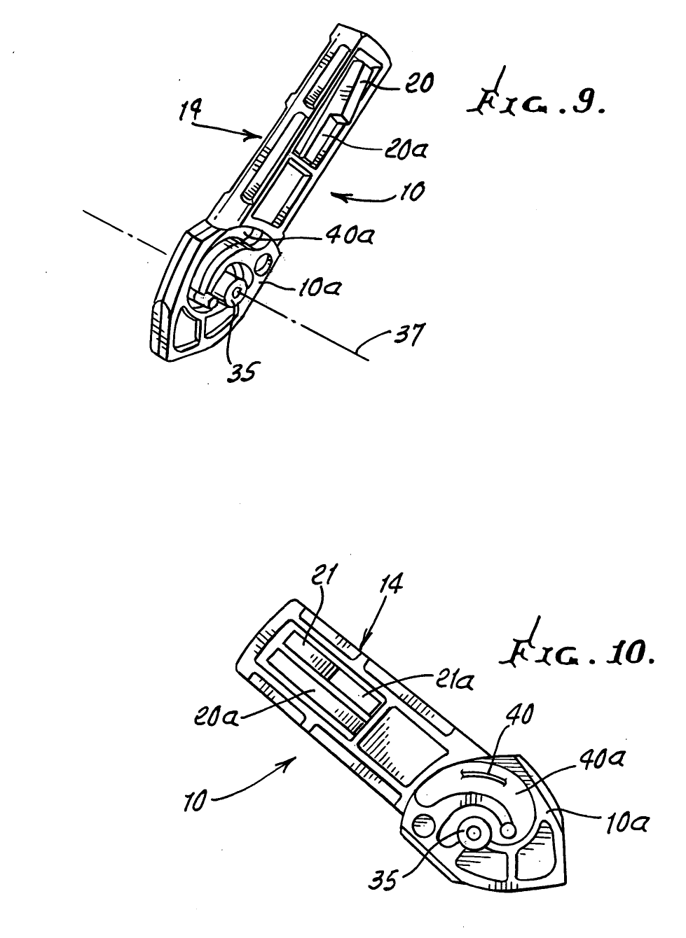

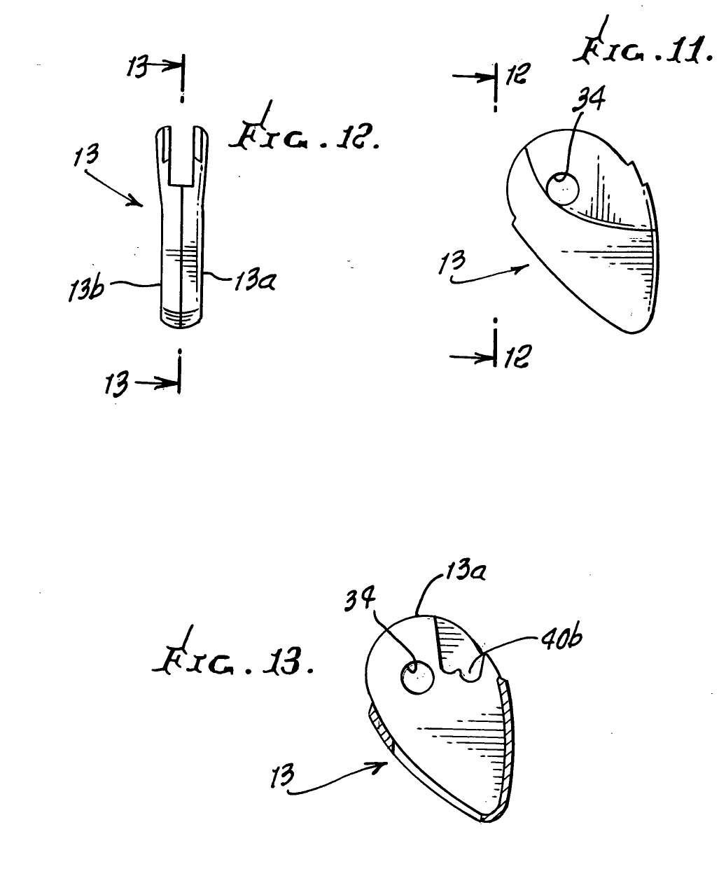

Shield 13 for the blade includes opposite sections 13a and 13b (see FIG. 4) extending at opposite sides of the blade. Holes 34 carried by the sections 13a and 13b interfit post 35 formed on the intermediate cartridge body 10a. The post 35 defines a lateral axis 37 (see FIG. 9), about which the shield is rotatable between positions as seen in FIGS. 3 and 4. User's finger application to a concave shoulder 38 on the shield acts to effect such rotation, (see arrow 38a in FIG. 5), which exposes the blade forward end portion for cutting. A curved spring 40 carried in groove 40a body portion 10a (see FIG. 10) yieldably urges the shield toward FIG. 3 position, the spring being tensioned as the shield is rotated toward FIG. 5 open position. The spring has anchor ends retained at 40b in body 10a and at 40b in the shield (see FIG. 13).

Finally, the blade cartridge can be made highly visible, for safety by providing at with external coloring or colors. This enhances cartridge and blade discernment, for easy retrieval to avoid contaminating surroundings.

1. In a knife, the combination, comprising
a) a cartridge,
b) a blade carried by a portion of the cartridge,
c) a holder supporting the cartridge so that the blade projects from the holder,
d) a shield for the blade, carried to be displaced relative to the holder and blade to expose the blade, for cutting.

2. The combination of claim 1 wherein the shield is removably and pivotally carried by the cartridge.

3. The combination of claim 2 wherein the cartridge defines a pivot to which the shield has connection.

4. The combination of claim 1 wherein the cartridge is received by the holder to be removable and replaceable.

5. The combination of claim 4 wherein the cartridge defines an elongated portion supported by an elongated handle portion of the holder.

6. The combination of claim 5 wherein the blade projects endwise relative to said handle portion of the holder.

7. The combination of claim 5 including a detent connection holding the cartridge elongated portion to said elongated handle portion of the holder.

8. The combination of claim 1 wherein said holder includes a handle portion defining ribs which extend generally transversely of handle portion length.

9. The combination of claim 7 wherein said holder handle portion defines outwardly exposed ribs which extend generally transversely to handle portion length.

10. The combination of claim 1 including guide means whereby the shield is rotatable forwardly and whereby the shield retracts bodily as it is rotated rearwardly toward open position exposing the blade edge.

11. The combination of claim 10 including a return spring located to urge the shield toward closed position.

12. The combination of claim 1 wherein the shield is rotatably supported by the cartridge.

13. The combination of claim 1 whereby the shield comprises two sections that are held together at opposite sides of the blade and at opposite sides of said portion of the cartridge.
